(19) United States
(12) Patent Application Publication
(10) Pub. No.: US 2012/0048200 A1
(43) Pub. Date: Mar. 1, 2012

(54) GRAVITY POULTRY FEEDER

(76) Inventor: James Bryan Evans, Waynesboro, GA (US)

(21) Appl. No.: 13/182,321

(22) Filed: Jul. 13, 2011

Related U.S. Application Data
(60) Provisional application No. 61/376,325, filed on Aug. 24, 2010.

(51) Int. Cl. A01K 39/014

(52) U.S. Cl. 119/51.01

(57) ABSTRACT

A gravity poultry feeder includes feeding ports designed to eliminate feed waste and contamination. In addition, the present invention provides a gravity poultry feeder that prevents bird droppings from being deposited in either the feeding area or feed reservoir. The feeder for poultry includes a reservoir, a plurality of feeding ports placed near the bottom end of the reservoir, and a baffled feed port connected to each feeding port. The bottom end of the reservoir includes a raised center.

### CROSS-REFERENCE TO RELATED APPLICATIONS

This application claims the benefit of priority to U.S. Provisional Application No. 61/376,325 filed Aug. 24, 2010, the contents of which are incorporated herein by reference.

### BACKGROUND OF THE INVENTION

The present invention generally relates to poultry feeders. More particularly, the present invention relates to a gravity poultry feeder including feeding ports designed to eliminate feed waste and contamination.

Contamination of feed by bird droppings is a constant problem when growing birds in a confined space. Feed contaminated with droppings creates a health hazard for the birds during the growing process. Typically, the birds are fed by using open pans or trough type feeders. Unfortunately, the known bird feeders include a depression around the base. The depression allows the birds to scatter the feed and to contaminate the feed with their droppings.

As can be seen, there is a need for a bird feeder that eliminates the waste of feed. In addition, there is a need for a bird feeder that prevents the contamination of the feed.

### SUMMARY OF THE INVENTION

In one aspect of the present invention, a feeder for poultry includes a reservoir, a plurality of feeding ports placed near the bottom end of the reservoir, and a baffled feed port inserted into each feeding port. The bottom end of the reservoir includes a raised center.

These and other features, aspects and advantages of the present invention will become better understood with reference to the following drawings, description and claims.

### BRIEF DESCRIPTION OF THE DRAWINGS

FIG. 1 illustrates a perspective front view of a gravity poultry feeder according to an exemplary embodiment of the present invention showing the poultry feeder being used by a bird;

FIG. 2 illustrates a perspective front view of the poultry feeder reservoir of FIG. 1;

FIG. 3 illustrates a perspective front view of a baffled feeding port of FIG. 1;

FIG. 4 illustrates an exploded view of the poultry feeder of FIG. 1;

FIG. 5 illustrates a cross-sectional view of the poultry feeder taken along line 5-5 in FIG. 2;

FIG. 6 illustrates a top view of the poultry feeder of FIG. 2;

FIG. 7 illustrates a cross-sectional view of the poultry feeder taken along line 7-7 in FIG.1;

FIG. 8 illustrates a perspective front view of a gravity poultry feeder according to another exemplary embodiment of the present invention; and

FIG. 9 illustrates a front view of the poultry feeder of FIG. 8.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a gravity poultry feeder including baffled feeding ports designed to eliminate feed waste and contamination. In addition, the present invention provides a gravity poultry feeder that prevents bird droppings from being deposited in either the feeding area or feed reservoir.

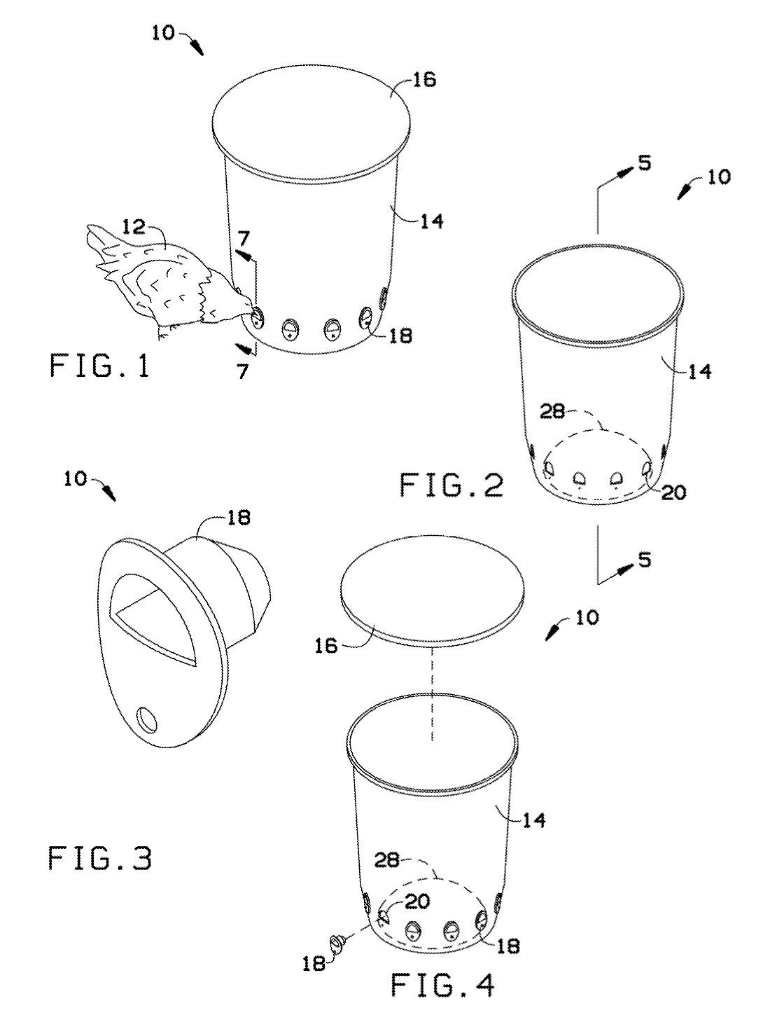

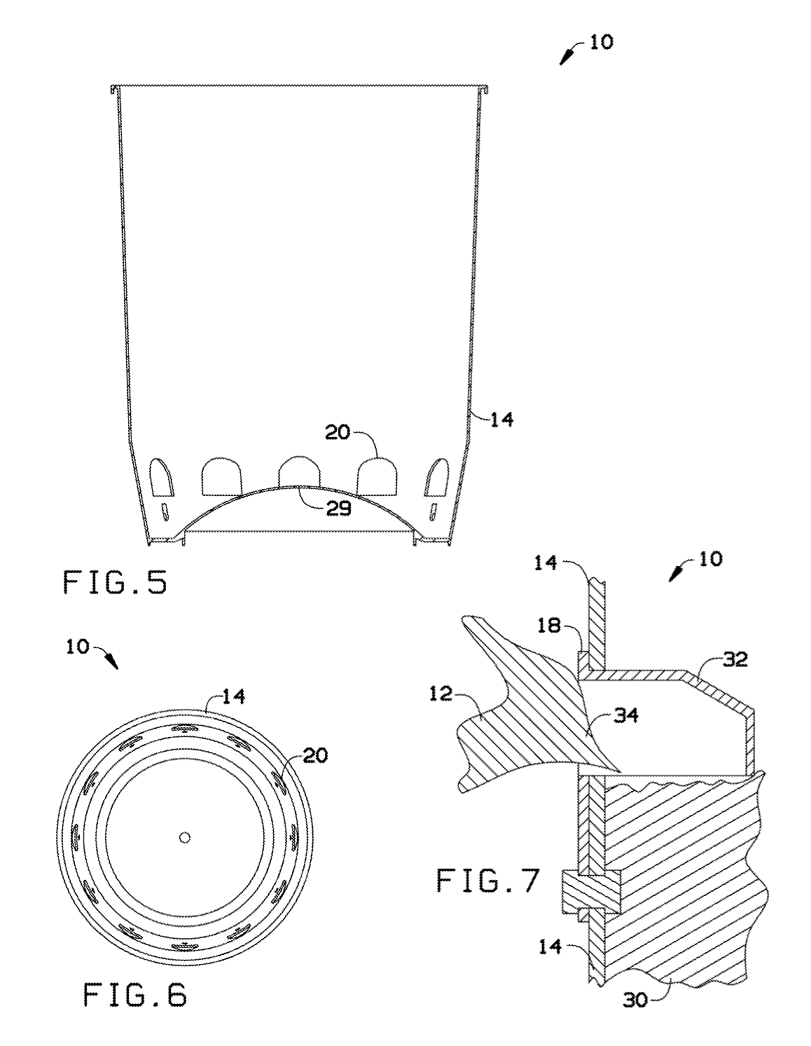

FIGS. 1-7 illustrate a gravity poultry feeder 10 according to an exemplary embodiment of the present invention. The gravity poultry feeder 10 may include a reservoir 14, a plurality of feeding ports 20 placed around the reservoir 14, and a baffled feed port 18 connected to each feeding port 20.

Poultry feed 30 may be poured into the reservoir 14. The reservoir 14 may be covered with a lid 16. As the poultry 12 obtains poultry feed 30 through the baffled feed port 18, the poultry feed 30 may be gradually replenished at each baffled feed port 18.

The reservoir 14 may be made of a sturdy material. In some embodiments, the reservoir 14 may be made of plastic, metal, composite material, polymer, glass, or wood. The reservoir 14 may include a handle (not shown) which may be made of plastic or metal. The reservoir 14 may have a geometrical shape. In some embodiments, the shape of the reservoir 14 may be a cylinder, a cube, a cone, a prism, or a sphere. In some embodiments, the reservoir 14 may be a cylinder having a height between 12 and 36 inches tall and 10 to 16 inches in diameter. In some embodiments, the reservoir 14 may be a cylinder having a height between 14 to 29 inches and a diameter of 12 inches.

The reservoir 14 may include a bottom end 28. The bottom end 28 may include a raised center 29. The height of the raised center 29 may depend on the size of the reservoir 14. In some embodiments, the height of the raised center 29 may be between 2 and 4 inches. In some embodiments, the height of the raised center 29 may be 2.5 inches. The raised center 29 may promote the flow of the poultry feed 30 towards the baffled feed ports 18. In addition, the raised center 29 may prevent the poultry feed 30 from getting trapped in the center of the reservoir 14. The raised center 29 may be integrated or removable to the bottom end 28 of the reservoir 14. In some embodiments the raised center 29 may be vacuum formed on the bottom end 28.

The size and shape of the lid 16 may depend on the size and shape of the reservoir 14. In some embodiments, the lid may have a diameter of about 12 inches. The lid 16 may be made of the same material as the reservoir 14. The lid 16 may include a hole (not shown) adapted to connect an automatic filling device (not shown).

The baffled feed ports 18 may be made of a sturdy material. In some embodiments, the baffled feed ports 18 may be made of metal, cast metal, or plastic. The baffled feed ports 18 may be positioned close to the bottom end 28 of the reservoir 14. The baffled feed ports 18 may be designed to prevent the poultry feed 30 from flowing out of the reservoir 14. In addition, the baffled feed ports 18 may be designed to allow the poultry 12 to easily access the poultry feed 30. The number of baffled feed ports 18 may depend on the size of the reservoir. The reservoir 14 may include 6 to 14 baffled feed ports 18. In some embodiments, the reservoir 14 may include 12 baffled feed ports 18. The baffled feed ports 18 may be approximately 2 to 2.5 inches tall and 1.5 to 2 inches wide. The baffled feed ports 18 may allow the poultry 12 to eat the poultry feed 30 without scattering it. The baffled feed ports 18 may be made by injection molding, molding, or by metal casting. The baffled feed ports 18 may be secured to the feeding port 20 by welding, rivet, glue, adhesive, or bolts and nuts fastening system.

FIG. 7 shows that the baffled feed ports 18 may include a hood 32 that protrudes inside the reservoir 14. In some embodiments, the hood 32 may protrude approximately 1 to 1.75 inches inside the reservoir 14.

The design and size of the baffled feed port 18 may only allow the poultry 12 to introduce its beak 34 inside the baffled feed port 18; waste and contamination of the poultry feed 30 is prevented.

The gravity poultry feeder 10 allows the user to use less poultry feed 30 reducing production costs. In addition, the gravity poultry feeder 10 may allow the use of the same feeder throughout the growing process from one day old chicks to adult birds.

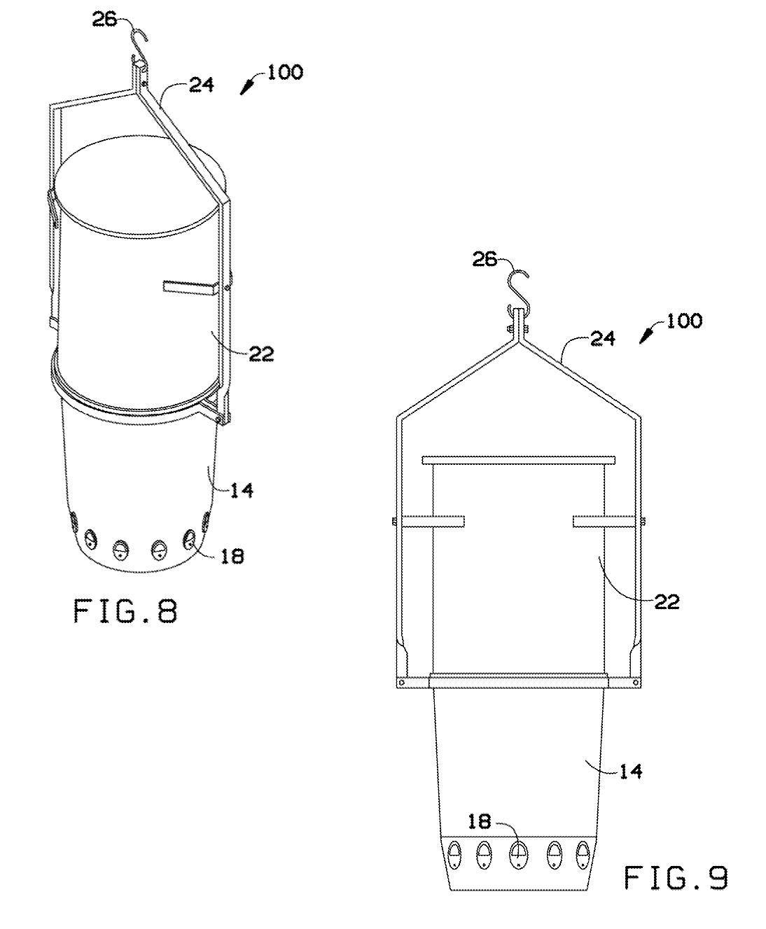

FIGS. 8-9 illustrate a gravity poultry feeder 100 according to another exemplary embodiment of the present invention. The gravity poultry feeder 100 may include an extension feeder reservoir 22 connected to the top of the reservoir 14. The extension feeder reservoir 22 may allow the user to double the capacity of the gravity poultry feeder 10. In some embodiments the reservoirs 14 and 22 are joined together using clamps, jigs, or a nut and bolt assembly. In some embodiments, the extension feeder reservoir 22 and the reservoir 14 may be connected using a female and male snap on locking system.

In some embodiments, the feeder 100 may be suspended off the ground using bracket 24, designed for this purpose.

A hanging hook 26 may be added to the gravity feeder 10, 100. The hanging hook 26 may help the user to raise the gravity feeder 10, 100 above the ground in order to feed adult poultriesl2.

The gravity poultry feeder 10 may be used to feed all types of birds. The gravity poultry feeder 10 may be used at ground level. The gravity feeder 10 can be either raised up on blocks or suspended off the ground by a chain, rope, or cable, using the hanging hook 26.

The design of the gravity poultry feeder 10 may eliminate the need to change the poultry feed 30 settings as the birds grow because the baffled feed ports 18 deliver a constant flow of the poultry feed 30 to the poultry 12 as it is removed from the baffled feed port 18. The design of the gravity poultry feeder 10 may eliminate the need for a trough or pan to dispense the poultry feed 30, which prevents the ability for the poultry 12 of depositing droppings in the poultry feed 30. The design of the gravity poultry feeder 10 may reduce the ability for the poultry 12 to waste the poultry feed 30.

It should be understood, of course, that the foregoing relates to exemplary embodiments of the invention and that modifications may be made without departing from the spirit and scope of the invention as set forth in the following claims.

What is claimed is:

1. A feeder for a poultry comprising:
a reservoir having a hollow core, a top end, a bottom end, and side walls;
a plurality of feeding ports placed near the bottom end of the reservoir;
a baffled feed port connected to each feeding port; and
wherein the bottom end of the reservoir includes a raised center.

2. The feeder according to claim 1, further including a lid placed at the top end of the reservoir.

3. The feeder according to claim 1, wherein each baffled feed port includes a hood that protrudes inside the hollow core of the reservoir.

4. The feeder according to claim 1, further including an extension feeder reservoir connected to the top end of the reservoir.

5. The feeder according to claim 4, wherein the extension feeder reservoir is connected to the reservoir by a female and male snap on locking system.

6. The feeder according to claim 5, wherein the feeder is suspended a hanger bracket that includes clamps or jigs.

7. The feeder according to claim 1, further including a hanging hook attached to the top end of the reservoir.

8. The feeder according to claim 1, wherein each baffled feed port has approximately 2 to 2.5 inches in height and 1.5 to 2 inches in width.

9. The feeder according to claim 1, wherein the raised center raises from the bottom end between 2 and 4 inches.

10. The feeder according to claim 1, wherein the raised center is vacuum formed on the bottom end.
